(19) United States
(12) Patent Application Publication
(10) Pub. No.: US 2025/0137835 A1
(43) Pub. Date: May 1, 2025

(54) VEHICLE CONTROL SYSTEM

(71) Applicant: ADVICS CO., LTD., Kariya-shi, Aichi-ken (JP)

(72) Inventors: Takuya HAYAKAWA, Kariya-shi, Aichi-ken (JP); Yasushi YAMANE, Kariya-shi, Aichi-ken (JP)

(73) Assignee: ADVICS CO., LTD., Kariya-shi, Aichi-ken (JP)

(21) Appl. No.: 18/847,020

(22) PCT Filed: Jul. 29, 2022
(86) PCT No.: PCT/JP2022/029378

§ 371 Date: Sep. 13, 2024

(30) Foreign Application Priority Data
Mar. 31, 2022 (JP) 2022-058580

(51) Int. Cl. G01G 19/08; G07C 5/02

(52) U.S. Cl. CPC G01G 19/086; G07C 5/02

(57) ABSTRACT

A vehicle control system includes an information acquisition unit that acquires traveling state information each time, an information storage unit that stores the traveling state information acquired by the information acquisition unit, and a weight estimation unit that derives an estimated value of a vehicle weight based on traveling state information satisfying a predetermined selection condition among a plurality of pieces of traveling state information stored by the information storage unit. The selection condition is a condition under which disturbance in derivation of the estimated value of the vehicle weight by the weight estimation unit is reduced.

### TECHNICAL FIELD

The present disclosure relates to a vehicle control system having a function of estimating a vehicle weight.

### BACKGROUND ART

PTL 1 discloses a control apparatus that derives an estimated value of a vehicle weight by dividing a driving force of a vehicle before shifting of a t transmission by a value obtained by subtracting a deceleration during shifting from an acceleration of the vehicle before shifting.

### CITATION LIST

### Patent Literature

PTL 1: JP 2002-13620 A

### SUMMARY

### Technical Problem

In recent years, along with expansion of self-driving, car sharing services, and data services for vehicles, and the like, improvement in estimation accuracy of a vehicle weight is required. An object of the present disclosure is to provide a vehicle control system that improves estimation accuracy of a vehicle weight.

### Solution to Problem

A vehicle control system for solving the above problem includes: an information acquisition unit configured to acquire a braking or driving force and an acceleration of a vehicle as traveling state information each time; an information storage unit configured to store the traveling state information acquired by the information acquisition unit; and a weight estimation unit configured to derive an estimated value of a vehicle weight based on the traveling state information satisfying a predetermined selection condition among a plurality of pieces of the traveling state information stored by the information storage unit. The selection condition is a condition under which disturbance in derivation of the estimated value of the vehicle weight by the weight estimation unit is reduced.

In the vehicle control system, the estimated value of the vehicle weight is derived based on the traveling state information satisfying the selection condition among the plurality of pieces of traveling state information. Here, the selection condition is a condition under which disturbance in estimation of the vehicle weight is reduced. Therefore, it is possible to reduce disturbance in the estimation of the vehicle weight and improve estimation accuracy of the vehicle weight.

### BRIEF DESCRIPTION OF DRAWINGS

FIG. 1 is a schematic diagram showing a schematic configuration of a vehicle including a vehicle control system of a first embodiment.

FIG. 2 is a flowchart showing traveling state information acquisition processing executed by the vehicle control system of the first embodiment.

FIG. 3 is a flowchart showing sample value derivation processing executed by the vehicle control system of the first embodiment.

FIG. 4 is a flowchart showing valid sample value selection processing executed by the vehicle control system of the first embodiment.

FIG. 5 is a flowchart showing vehicle weight estimation processing executed by the vehicle control system of the first embodiment.

FIG. 6 is a flowchart showing wear amount estimation processing executed by the vehicle control system of the first embodiment.

FIG. 7 is a configuration diagram showing a vehicle control system of a second embodiment.

FIG. 8 is a sequence diagram showing processing executed by the vehicle control system of the second embodiment.

### DESCRIPTION OF EMBODIMENTS

### First Embodiment

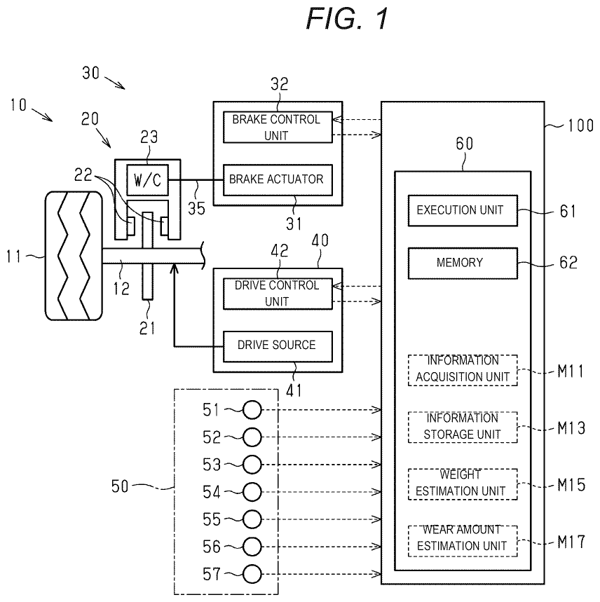

Hereinafter, a first embodiment of the vehicle control system will be described with reference to FIGS. 1 to 6.

FIG. 1 is a configuration diagram showing a schematic configuration of a vehicle 10 including a vehicle control system 100. The vehicle 10 further includes a plurality of wheels 11, a brake apparatus 30, a drive apparatus 40, and a detection system 50.

### <Brake Apparatus>

The brake apparatus 30 includes a wheel brake mechanism 20, a brake actuator 31, and a brake control unit 32.

The wheel brake mechanism 20 includes a rubbed portion 21, a friction portion 22, and a wheel cylinder 23. When a hydraulic pressure (hereinafter referred to as “wheel cylinder pressure”) is generated in the wheel cylinder 23, the friction portion 22 is pressed against the rubbed portion 21 that rotates together with the wheel 11. At this time, a larger braking force is applied to the wheel 11 as a force pressing the friction portion 22 against the rubbed portion 21 increases.

The brake actuator 31 is connected to the wheel cylinder 23 via a fluid passage 35. The brake actuator 31 increases or decreases the wheel cylinder pressure.

The brake control unit 32 includes an execution unit and a memory. For example, the execution unit is a CPU. The memory stores control programs to be executed by the execution unit. The execution unit controls the brake actuator 31 by executing the control programs.

### <Drive Apparatus>

The drive apparatus 40 includes a drive source 41 and a drive control unit 42 of the vehicle 10. The drive apparatus 40 includes at least one of an engine and a traveling motor as the drive source 41. A torque output from the drive source 41 is input to the wheel 11 via an axle 12.

The drive control unit 42 includes an execution unit and a memory. For example, the execution unit is a CPU. The memory stores control programs to be executed by the execution unit. The execution unit controls the drive source 41 by executing the control programs.

### <Detection System>

The detection system 50 includes a plurality of types of sensors that detect a traveling state of the vehicle 10. The detection system 50 includes a wheel speed sensor 51, a longitudinal acceleration sensor 52, a lateral acceleration sensor 53, a yaw rate sensor 54, an accelerator operation amount sensor 55, a brake operation amount sensor 56, and a steering angle sensor 57. The wheel speed sensor 51 detects a wheel speed Vw that is a rotation speed of the wheel 11. The longitudinal acceleration sensor 52 detects a longitudinal acceleration Gx of the vehicle 10. The lateral acceleration sensor 53 detects a lateral acceleration Gy of the vehicle 10. The yaw rate sensor 54 detects a yaw rate Yr of the vehicle 10. The accelerator operation amount sensor 55 detects an accelerator operation amount Accp that is an operation amount of an accelerator pedal by a driver of the vehicle. The brake operation amount sensor 56 detects a brake operation amount BP that is an operation amount of a brake pedal by the driver. The steering angle sensor 57 detects a steering angle Str that is an operation amount of a steering wheel by the driver. The various sensors 51 to 57 output, to the vehicle control system 100, detection signals corresponding to detection values.

### <Vehicle Control System>

The vehicle control system 100 includes a control apparatus 60. The control apparatus 60 transmits and receives various types of information to and from the brake control unit 32 and the drive control unit 42. The control apparatus 60 includes an execution unit 61 and a memory 62. For example, the execution unit 61 is a CPU. The memory 62 stores various control programs to be executed by the execution unit 61.

By executing the control programs, the execution unit 61 functions as an information acquisition unit M11, an information storage unit M13, a weight estimation unit M15, and a wear amount estimation unit M17.

The information acquisition unit M11 acquires traveling state information X of the vehicle 10 during traveling each time.

Specifically, the information acquisition unit M11 acquires a braking or driving force and the longitudinal acceleration Gx of the vehicle 10 as the traveling state information X. The information acquisition unit M11 acquires a driving force Ds of the vehicle 10 as the braking or driving force when the vehicle 10 accelerates, and acquires a braking force Bs of the vehicle 10 as the braking or driving force when the vehicle 10 decelerates.

Specifically, the information acquisition unit M11 derives the longitudinal acceleration Gx based on a detection value of the longitudinal acceleration sensor 52. The information acquisition unit M11 derives the driving force Ds based on a detection value of the accelerator operation amount sensor 55. The information acquisition unit M11 derives the braking force Bs based on a detection value of the brake operation amount sensor 56.

The information acquisition unit M11 may set a required driving force derived by the drive control unit 42 as the driving force Ds, or may set a required braking force derived by the brake control unit 32 as the braking force Bs.

In the present embodiment, the information acquisition unit M11 acquires, as the traveling state information X, the yaw rate Yr of the vehicle 10, the accelerator operation amount Accp, the steering angle Str, a traveling speed Vs of the vehicle 10, a lateral force Fy of the vehicle 10, a drive torque Tod of a drive shaft of the vehicle 10, and a road surface gradient θ that is a gradient of a road surface on which the vehicle 10 travels, in addition to the braking or driving force and the longitudinal acceleration Gx.

For example, the information acquisition unit M11 derives the yaw rate Yr based on a detection value of the yaw rate sensor 54. The information acquisition unit M11 derives the accelerator operation amount Accp based on a detection value of the accelerator operation amount sensor 55. The information acquisition unit M11 derives the steering angle Str based on a detection value of the steering angle sensor 57. The information acquisition unit M11 derives the traveling speed Vs based on a detection value of the wheel speed sensor 51. The information acquisition unit M11 acquires the lateral force Fy based on a vehicle weight grasped at that time and a detection value of the lateral acceleration sensor 53. The information acquisition unit M11 derives the drive torque Tod of the drive shaft based on the driving force Ds of the vehicle 10. The information acquisition unit M11 derives a difference between a value of a time derivative of the traveling speed Vs and the longitudinal acceleration Gx based on the detection values of the wheel speed sensor 51 and the longitudinal acceleration sensor 52, and acquires a value corresponding to the difference as the road surface gradient θ.

The information acquisition unit M11 may set a required steering angle as the steering angle Str.

The information storage unit M13 stores the traveling state information X acquired by the information acquisition unit M11 in a predetermined storage area of the memory 62.

In the present embodiment, the information storage unit M13 stores, in the memory 62, the braking or driving force, the longitudinal acceleration Gx, the yaw rate Yr, the accelerator operation amount Accp, the steering angle Str, the traveling speed Vs, the lateral force Fy, the drive torque Tod, and the road surface gradient θ.

Accordingly, each time the traveling state information X is acquired by the information acquisition unit M11, the traveling state information X is stored in the predetermined storage area of the memory 62. Therefore, for example, when an ignition switch of the vehicle 10 is turned off, that is, when one trip of the vehicle 10 is completed, a plurality of pieces of traveling state information X acquired during the one trip is stored in the memory 62.

The weight estimation unit M15 derives an estimated value W of the vehicle weight based on the traveling state information X satisfying a predetermined selection condition among the plurality of pieces of traveling state information X stored in the memory 62 by the information storage unit M13. Here, the selection condition is a condition under which disturbance in estimation of the vehicle weight by the weight estimation unit M15 is reduced. In other words, the selection condition is a condition for removing the traveling state information X that decreases estimation accuracy when estimating the vehicle weight based on the traveling state information X.

In the present embodiment, the weight estimation unit M15 determines that the traveling state information X satisfies the selection condition when all of a plurality of values acquired as the traveling state information X are each within a predetermined range. Specifically, the weight estimation unit M15 determines that the traveling state information X satisfies the selection condition when all of the following conditions (A1) to (A10) are satisfied. On the other hand, when at least one of the following conditions (A1) to (A10) is not satisfied, the weight estimation unit M15 determines that the traveling state information X does not satisfy the selection condition.

Here, predetermined ranges of absolute values of the braking or driving force, the accelerator operation amount Accp, the drive torque Tod, the traveling speed Vs, and the longitudinal acceleration Gx are ranges equal to or larger than corresponding determination values. Predetermined ranges of an absolute value of the steering angle Str, an absolute value of the yaw rate Yr, the lateral force Fy, and an absolute value of the road surface gradient θ are ranges equal to or smaller than corresponding determination values.

Hereinafter, determination of whether the traveling state information X satisfies the selection condition is referred to as “traveling state determination”.
(A1) The braking or driving force (that is, the driving force Ds or the braking force Bs) is equal to or larger than a braking or driving force determination value.
(A2) The accelerator operation amount Accp is equal to or larger than an operation amount determination value.
(A3) The drive torque TQd is equal to or larger than a drive torque determination value.
(A4) The traveling speed Vs is equal to or larger than a traveling speed determination value.
(A5) The absolute value of the steering angle Str is equal to or smaller than a steering angle determination value.
(A6) The absolute value of the yaw rate Yr is equal to or smaller than a yaw rate determination value.
(A7) The lateral force Fy is equal to or smaller than a lateral force determination value.
(A8) The absolute value of the longitudinal acceleration Gx is equal to or larger than an acceleration determination value.
(A9) The absolute value of the road surface gradient θ is equal to or smaller than a gradient determination value.
(A10) The road surface gradient θ indicates an uphill road.

The braking or driving force determination value, the operation amount determination value, the drive torque determination value, and the traveling speed determination value are set as criteria for determining whether the vehicle 10 is creeping. When all of the conditions (A1) to (A4) are satisfied, it is considered that the vehicle 10 is not creeping. On the other hand, when at least one of the conditions (A1) to (A4) is not satisfied, it is considered that the vehicle 10 may be creeping.

The steering angle determination value, the yaw rate determination value, and the lateral force determination value are set as criteria for determining whether the vehicle 10 is cornering. When all of the conditions (A5) to (A7) are satisfied, it is considered that there is no possibility that the vehicle 10 is cornering. On the other hand, when at least one of the conditions (A5) to (A7) is not satisfied, it is considered that the vehicle 10 may be cornering.

Here, disturbance such as a gravitational acceleration component due to the road surface gradient θ is superimposed on the longitudinal acceleration Gx derived from the detection value of the longitudinal acceleration sensor 52. As the absolute value of the longitudinal acceleration Gx decreases, a proportion of the disturbance component in the longitudinal acceleration Gx increases. Therefore, when the absolute value of the longitudinal acceleration Gx is small, it is conceivable that the estimation accuracy of the vehicle weight based on the longitudinal acceleration Gx decreases.

Therefore, the acceleration determination value is set as a criterion for determining whether the proportion of the disturbance component in the longitudinal acceleration Gx is small. When the condition (A8) is satisfied, it is considered that the proportion of the disturbance component in the longitudinal acceleration Gx is relatively small. When the condition (A8) is not satisfied, it is considered that the proportion of the disturbance component in the longitudinal acceleration Gx is relatively large.

As the absolute value of the road surface gradient θ increases, the proportion of the gravitational acceleration component due to the road surface gradient θ in the longitudinal acceleration Gx derived from the detection value of the longitudinal acceleration sensor 52 increases. Therefore, when the absolute value of the road surface gradient θ is large, it is conceivable that the estimation accuracy of the vehicle weight based on the longitudinal acceleration Gx decreases.

Therefore, the gradient determination value is set as a criterion for determining whether the proportion of the gravitational acceleration component in the longitudinal acceleration Gx is small. When the condition (A9) is satisfied, it is considered that the proportion of the gravitational acceleration component in the longitudinal acceleration Gx is relatively small. When the condition (A9) is not satisfied, it is considered that the proportion of the gravitational acceleration component in the longitudinal acceleration Gx is relatively large.

The weight estimation unit M15 derives a sample value WS of the vehicle weight based on the traveling state information X stored in the memory 62 by the information storage unit M13. Specifically, the weight estimation unit M15 derives the sample value WS using the following relationship equation (Equation 1). In the relationship equation (Equation 1), “F” is a braking or driving force, and the driving force Ds or the braking force Bs is substituted into “F”. In addition, “σ” is an air density, “Cd” is an aerodynamic drag coefficient, and “S” is a frontal projected area of the vehicle 10. In addition, “V” is a vehicle speed, and the traveling speed Vs is substituted into “V”. In addition, “a” is an acceleration, and the longitudinal acceleration Gx is substituted into “a”. In addition, “c” is a rolling resistance coefficient, and “g” is a gravitational acceleration.

$$[ Formula 1 ]$$

$$WS = \frac{F - \frac{1}{2} \times σ \times C d \times S \times {V}^{2}}{a + c \times g} \qquad ( EQUATION 1 )$$

Here, the relationship equation (Equation 1) is an equation obtained by converting an equation of motion expressed by the following relationship equation (Equation 2). In the relationship equation (Equation 2), “M” is a vehicle weight. In addition, “(½)×σ×Cd×S×V²” indicates an aerodynamic drag of the vehicle 10, and “c×M×g” indicates a rolling resistance of the wheel 11.

$$[ Formula 2 ]$$

$$F = M \times a + \frac{1}{2} \times σ \times C d \times S \times {V}^{2} + c \times M \times g \qquad ( EQUATION 2 )$$

The weight estimation unit M15 selects, from the plurality of sample values WS of the vehicle weight, the sample value WS derived based on the traveling state information X satisfying the selection condition as a valid sample value VWS. In other words, the weight estimation unit M15 excludes, from the plurality of sample values WS of the vehicle weight, the sample value WS derived based on the traveling state information X that does not satisfy the selection condition.

The weight estimation unit M15 derives the estimated value W of the vehicle weight by performing statistical processing on the plurality of valid sample values VWS. For example, the weight estimation unit M15 derives a median VWSm of the plurality of valid sample values VWS, and extracts, from the plurality of valid sample values VWS, the valid sample value VWS whose difference from the median VWSm is less than a predetermined difference AW. Then, the weight estimation unit M15 derives the estimated value W of the vehicle weight based on the plurality of extracted valid sample values VWS. For example, the weight estimation unit M15 derives an average value of the plurality of extracted valid sample values VWS as the estimated value W.

When the vehicle weight is estimated by the statistical processing as described above, it is conceivable that the estimation accuracy of the vehicle weight decreases as the number of the valid sample values VWS decreases. In the present embodiment, when a number Z of the valid sample values VWS is smaller than a predetermined value Zth, the estimated value W is set to a predetermined weight WE. Here, the predetermined weight WE may be a vehicle weight set based on specifications of the vehicle 10, the estimated value W derived in the past by the present estimated value derivation processing, or an estimated value derived by processing other than the present estimated value derivation processing.

The wear amount estimation unit M17 derives a wear amount ΔA of the friction portion 22 of the wheel brake mechanism 20 based on the vehicle weight. Specifically, the wear amount estimation unit M17 derives kinetic energy of the vehicle 10 lost due to braking based on the vehicle weight and the traveling speed Vs before and after braking. Then, the wear amount estimation unit M17 derives the wear amount ΔA of the friction portion 22 based on the kinetic energy, for example, using a known technique disclosed in “U.S. Pat. No. 10,486,674 B”.

Here, the wear amount ΔA of the friction portion 22 derived by the wear amount estimation unit M17 is an estimated value of a wear amount due to traveling of the vehicle 10 during a period in which the traveling state information X is stored in the memory 62. For example, when the period in which the traveling state information X is stored in the memory 62 is one trip of the vehicle 10, the wear amount ΔA of the friction portion 22 is an estimated value of the wear amount of the vehicle 10 in one trip.

When the vehicle weight is estimated using the statistical processing as described above, it is conceivable that the estimation accuracy of the vehicle weight decreases as the traveling state of the vehicle 10 corresponding to the valid sample value VWS is biased to a specific traveling state. It is conceivable that the traveling state of the vehicle 10 is biased to the specific traveling state as a traveling distance Lv of the vehicle 10 is shorter.

The wear amount estimation unit M17 selects the estimated value W when the traveling distance Lv of the vehicle 10 in an acquisition period of the traveling state information X is equal to or longer than a determination traveling distance Lvth, and selects the predetermined weight WE when the traveling distance Lv is shorter than the determination traveling distance Lvth.

### <Traveling State Information Acquisition Processing>

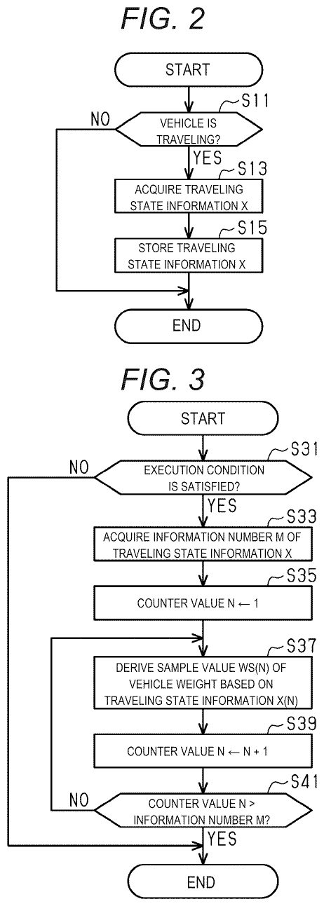

Traveling state information acquisition processing that is processing of acquiring the traveling state information X will be described with reference to FIG. 2. FIG. 2 is a flowchart showing a flow of the traveling state information acquisition processing. A control program corresponding to the traveling state information acquisition processing is repeatedly executed by the execution unit 61 at a predetermined cycle. In the present embodiment, the traveling state information X is repeatedly acquired while the ignition switch of the vehicle 10 is in an on state.

In step S11, the execution unit 61 determines whether the vehicle 10 is traveling. For example, the execution unit 61 determines whether the traveling speed Vs is equal to or higher than a traveling determination speed. When the traveling speed Vs is equal to or higher than the traveling determination speed, the execution unit 61 determines that the vehicle 10 is traveling (S11: YES), and proceeds to processing of step S13. On the other hand, when the traveling speed Vs is lower than the traveling determination speed, the execution unit 61 determines that the vehicle 10 is stopped (S11: NO), and ends the current processing.

In step S13, the execution unit 61 functions as the information acquisition unit M11 to acquire the traveling state information X based on the detection values of the various sensors 51 to 57 of the detection system 50.

In subsequent step S15, the execution unit 61 functions as the information storage unit M13 to store the traveling state information X acquired in step S13 in the predetermined storage area of the memory 62. Thereafter, the execution unit 61 ends the current processing.

### <Sample Value Derivation Processing>

Sample value derivation processing that is processing of deriving the sample value WS of the vehicle weight will be described with reference to FIG. 3. In the present processing, the plurality of sample values WS of the vehicle weight are derived based on a plurality of pieces of traveling state information X acquired in the traveling state information acquisition processing. FIG. 3 is a flowchart showing a flow of the sample value derivation processing. A control program corresponding to the sample value derivation processing is executed by the execution unit 61. The execution unit 61 functions as the weight estimation unit M15 to execute processing of a plurality of steps S31 to S41 constituting the sample value derivation processing.

In step S31, the execution unit 61 determines whether an execution condition for deriving the sample value WS of the vehicle weight is satisfied. In the present embodiment, the execution condition is that the ignition switch transitions from on to off. Specifically, when the ignition switch of the vehicle 10 transitions from on to off and one trip of the vehicle 10 ends, it is considered that the execution condition for deriving the sample value WS is satisfied. Since the ignition switch of the vehicle 10 is maintained to be on, it is considered that the execution condition is not satisfied when one trip of the vehicle 10 is not completed. The execution unit 61 proceeds to processing of step S33 when the execution condition is satisfied (S31: YES), and on the other hand, ends the current processing when the execution condition is not satisfied (S31: NO).

In step S33, the execution unit 61 acquires an information number M, which is the number of pieces of traveling state information X stored in the memory 62. In the next step S35, the execution unit 61 sets a counter value N to “1”. Thereafter, the execution unit 61 repeatedly executes processing of steps S37 and S39 for the information number M.

In step S37, the execution unit 61 reads traveling state information X (N) from the memory 62 and derives a sample value WS (N) of the vehicle weight based on the traveling state information X (N).

In step S39, the execution unit 61 increments the counter value N by 1. In the next step S41, the execution unit 61 determines whether the counter value N updated in step S39 is larger than the information number M acquired in step S33. When the counter value N is equal to or smaller than the information number M, there is still traveling state information X that is not used for deriving the sample value WS among the M pieces of traveling state information X stored in the memory 62. On the other hand, when the counter value N is larger than the information number M, there is no traveling state information X that is not used for deriving the sample value WS among the M pieces of traveling state information X stored in the memory 62. Therefore, the execution unit 61 returns to the processing of step S37 when the counter value N is equal to or smaller than the information number M (S41: NO), and ends the current processing when the counter value N is larger than the information number M (S41: YES).

### <Valid Sample Value Selection Processing>

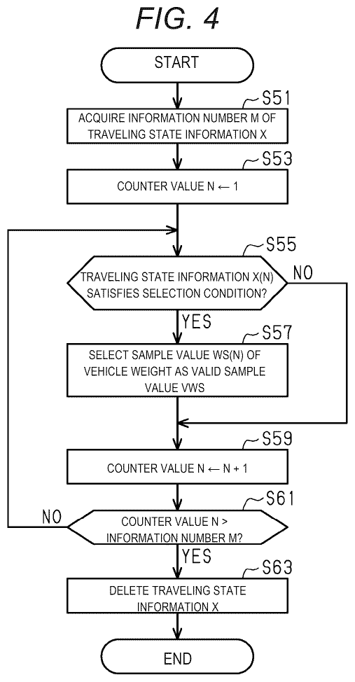

Valid sample value selection processing that is processing of selecting the valid sample value VWS used for estimating the vehicle weight from the sample values WS of the vehicle weight will be described with reference to FIG. 4. In the present processing, the valid sample value VWS is selected from the M sample values WS derived in the sample value derivation processing. FIG. 4 is a flowchart showing a flow of sample value deletion processing. A control program corresponding to the valid sample value selection processing is executed by the execution unit 61. The execution unit 61 functions as the weight estimation unit M15 to execute processing of a plurality of steps S51 to S63 constituting the valid sample value selection processing.

In step S51, the execution unit 61 acquires the information number M, which is the number of pieces of traveling state information X stored in the memory 62. In the subsequent step S53, the execution unit 61 sets the counter value N to 1. Thereafter, the execution unit 61 repeatedly executes processing of steps S55 to S59 for the information number M.

In step S55, the execution unit 61 performs traveling state determination on the traveling state information X (N) stored in the memory 62. The execution unit 61 proceeds to processing of step S57 when the traveling state information X (N) satisfies the selection condition (S55: YES), and proceeds to processing of step S59 when the traveling state information X (N) does not satisfy the selection condition (S55: NO).

In step S57, the execution unit 61 selects, as the valid sample value VWS, the sample value WS (N) derived based on the traveling state information X (N). Then, the execution unit 61 proceeds to the processing of step S59.

In step S59, the execution unit 61 increments the counter value N by 1. In the next step S61, the execution unit 61 determines whether the counter value N updated in step S59 is larger than the information number M acquired in step S51. When the counter value N is equal to or smaller than the information number M, there is traveling state information X for which the traveling state determination is not performed among the M pieces of traveling state information X stored in the memory 62. On the other hand, when the counter value N is larger than the information number M, there is no traveling state information X for which the traveling state determination is not performed among the M pieces of traveling state information X stored in the memory 62. Therefore, the execution unit 61 returns to the processing of step S55 when the counter value N is equal to or smaller than the information number M (S61: NO), and proceeds to processing of step S63 when the counter value N is larger than the information number M (S61: YES).

In step S63, the execution unit 61 deletes all the traveling state information X from the memory 62. Thereafter, the execution unit 61 ends the current processing.

### <Vehicle Weight Estimation Processing>

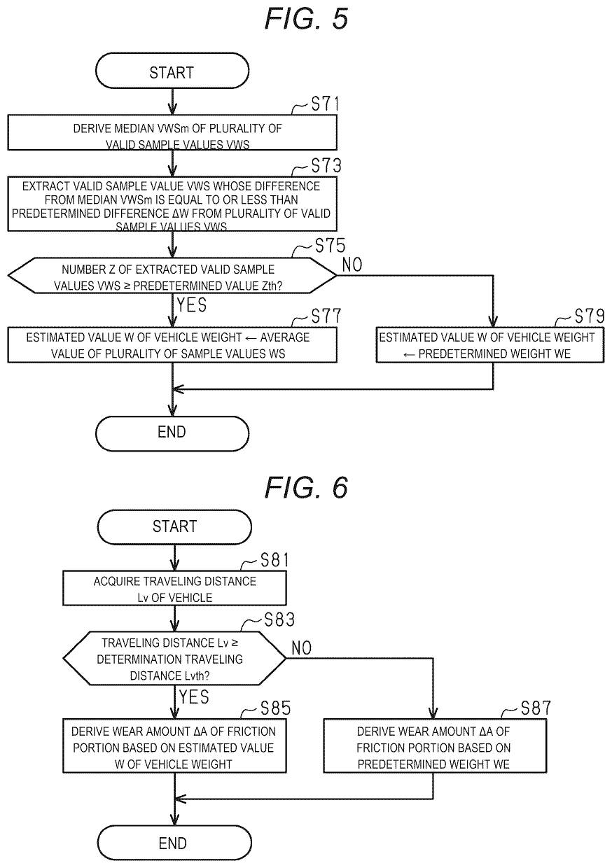

Vehicle weight estimation processing that is processing of estimating the vehicle weight will be described with reference to FIG. 5. In the present processing, the vehicle weight is estimated based on the valid sample value VWS selected in the valid sample value selection processing. FIG. 5 is a flowchart showing a flow of the vehicle weight estimation processing. A control program corresponding to the vehicle weight estimation processing is executed by the execution unit 61. The execution unit 61 functions as the weight estimation unit M15 to execute processing of a plurality of steps S71 to S79 constituting the vehicle weight estimation processing.

In step S71, the execution unit 61 derives the median VWSm of the valid sample values VWS of the vehicle weight.

In step S73, the execution unit 61 extracts the valid sample value VWS whose difference from the median VWSm is less than the predetermined difference AW from the plurality of valid sample values VWS. In other words, the execution unit 61 excludes, as an outlier, the valid sample value VWS whose difference from the median VWSm is equal to or more than the predetermined difference AW from the plurality of valid sample values VWS.

In step S75, the execution unit 61 acquires the number Z of the valid sample values VWS extracted in the processing of step S73, and determines whether the number Z is equal to or larger than the predetermined value Zth. The execution unit 61 proceeds to processing of step S77 when the number Z of the valid sample values VWS is equal to or larger than the predetermined value Zth (S75: YES), and proceeds to processing of step S79 when the number Z is smaller than the predetermined value Zth (S75: NO).

In step S77, the execution unit 61 derives the estimated value W of the vehicle weight based on the valid sample values VWS extracted in step S73. For example, the execution unit 61 derives, as the estimated value W of the vehicle weight, an average value of the valid sample values VWS extracted in step S73. Thereafter, the execution unit 61 ends the current processing.

In step S79, the execution unit 61 sets the estimated value W of the vehicle weight to the predetermined weight WE. Thereafter, the execution unit 61 ends the current processing.

### <Wear Amount Estimation Processing>

Wear amount estimation processing that is processing of deriving the wear amount ΔA of the friction portion 22 of the wheel brake mechanism 20 will be described with reference to FIG. 6. In the present processing, the wear amount ΔA is derived based on the estimated value W of the vehicle weight estimated in the vehicle weight estimation processing. FIG. 6 is a flowchart showing a flow of the wear amount estimation processing. A control program corresponding to the wear amount estimation processing is executed by the execution unit 61. The execution unit 61 functions as the wear amount estimation unit M17 to execute processing of a plurality of steps S81 to S87 constituting the wear amount estimation processing.

In step S81, the execution unit 61 acquires the traveling distance Lv of the vehicle 10 in one trip during which the traveling state information X is acquired.

In the next step S83, the execution unit 61 determines whether the traveling distance Lv acquired in step S81 is equal to or longer than the determination traveling distance Lvth. The execution unit 61 proceeds to processing of step S85 when the traveling distance Lv is equal to or longer than the determination traveling distance Lvth (S83: YES), and proceeds to processing of step S87 when the traveling distance Lv is shorter than the determination traveling distance Lvth (S83: NO).

In step S85, the execution unit 61 derives the wear amount ΔA of the friction portion 22 based on the estimated value W of the vehicle weight. Thereafter, the execution unit 61 ends the current processing.

In step S87, the execution unit 61 derives the wear amount ΔA of the friction portion 22 based on the predetermined weight WE. Thereafter, the execution unit 61 ends the current processing.

### Effects of Present Embodiment

(1-1) In the present embodiment, the estimated value W of the vehicle weight is derived based on the traveling state information X that satisfies the selection condition among the pieces of traveling state information X. The selection condition is a condition under which the disturbance in estimation of the vehicle weight is reduced. Therefore, according to the present embodiment, since the vehicle weight is estimated based on the traveling state information X with less disturbance in the estimation of the vehicle weight, the estimation accuracy of the vehicle weight can be improved.
(1-2) In the present embodiment, the estimated value W of the vehicle weight is derived by performing the statistical processing on the plurality of valid sample values VWS. According to the present embodiment, an influence of the disturbance on the estimation of the vehicle weight and a detection error of the detection system 50 on the estimation of the vehicle weight is reduced by the statistical processing, and thus the estimation accuracy of the vehicle weight can be further improved.
(1-3) In a case where the vehicle weight is estimated by performing the statistical processing on the plurality of valid sample values VWS of the vehicle weight as in the present embodiment, it is conceivable that the estimation accuracy of the vehicle weight is low when the number of the valid sample values VWS is small. In the present embodiment, when the number Z of the valid sample values VWS is smaller than the predetermined value Zth, the predetermined weight WE is derived as the estimated value W. According to the present embodiment, it is possible to prevent a decrease in the estimation accuracy of the vehicle weight due to the small number of valid sample values VWS.
(1-4) It is conceivable that the traveling state of the vehicle 10 is biased to the specific traveling state when the traveling distance Lv is short. Therefore, as in the present embodiment, in a case where the estimated value W of the vehicle weight is derived by performing the statistical processing on the plurality of valid sample values VWS of the vehicle weight, it is conceivable that the estimation accuracy of the estimated value W is low when the traveling distance Lv of the vehicle 10 is short. In the present embodiment, when the traveling distance Lv is shorter than the determination traveling distance Lvth, the wear amount ΔA of the friction portion 22 is derived using the predetermined weight WE instead of the estimated value W. According to the present embodiment, it is possible to prevent a decrease in the estimation accuracy of the vehicle weight due to bias of the traveling state of the vehicle 10 corresponding to the valid sample value VWS.

### Second Embodiment

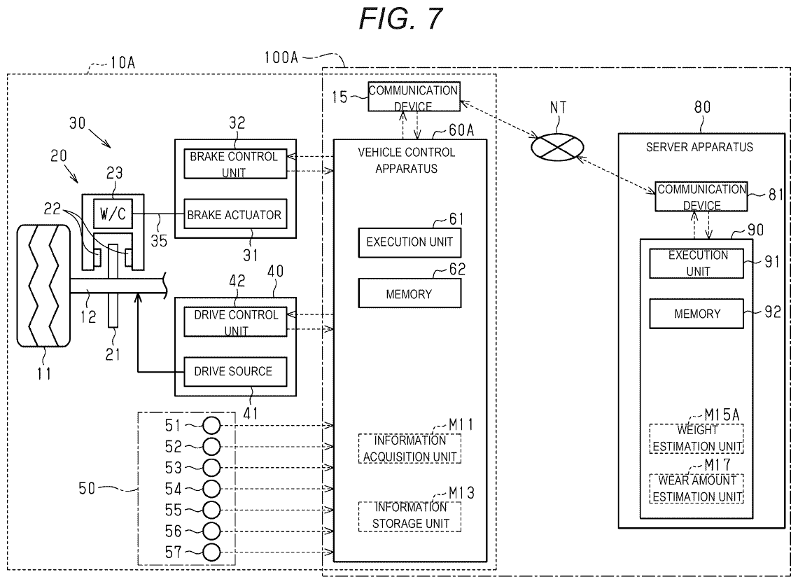

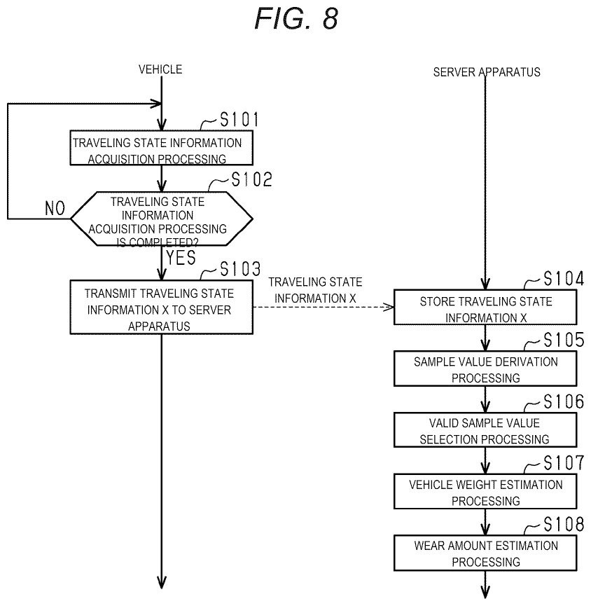

A second embodiment of the vehicle control system will be described with reference to FIGS. 7 and 8. The second embodiment is different from the first embodiment in that the vehicle control system includes a control apparatus provided outside the vehicle, and is different in control contents of the vehicle control system, for example. In the following description, portions different from those of the first embodiment are mainly described. The same members as those of the first embodiment are denoted by the same reference signs, and a repeated description thereof is omitted.

FIG. 7 is a schematic diagram showing a vehicle control system 100A of the present embodiment. The vehicle control system 100A includes a vehicle control apparatus 60A mounted on a vehicle 10A and a server apparatus 80 provided outside the vehicle 10A.

### <Vehicle>

The vehicle 10A includes a communication device 15 in addition to the plurality of wheels 11, the brake apparatus 30, the drive apparatus 40, the detection system 50, and the vehicle control apparatus 60A.

The communication device 15 transmits information output from the vehicle control apparatus 60A to the server apparatus 80 via a vehicle external network NT. The communication device 15 receives information transmitted from the server apparatus 80 via the vehicle external network NT, and outputs the received information to the vehicle control apparatus 60A.

The vehicle control apparatus 60A corresponds to a “first control apparatus” provided in the vehicle 10A. Similarly to the control apparatus 60 in the first embodiment, the vehicle control apparatus 60A transmits and receives various types of information to and from the brake control unit 32 and the drive control unit 42.

The vehicle control apparatus 60A includes the execution unit 61 and the memory 62.

The execution unit 61 functions as the information acquisition unit M11 and the information storage unit M13 by executing a control program.

### <Server Apparatus>

The server apparatus 80 includes a communication device 81 and a server control apparatus 90.

The communication device 81 transmits information output from the server control apparatus 90 to the vehicle 10A via the vehicle external network NT. The communication device 81 receives information transmitted from the vehicle 10A via the vehicle external network NT, and outputs the received information to the server control apparatus 90.

The server control apparatus 90 corresponds to a “second control apparatus” provided outside the vehicle 10A. The server control apparatus 90 includes an execution unit 91 and a memory 92. For example, the execution unit 91 is a CPU. The memory 92 stores various control programs to be executed by the execution unit 91.

By executing the control programs, the execution unit 91 functions as a weight estimation unit M15A and the wear amount estimation unit M17.

FIG. 8 is a sequence diagram showing a flow of a series of processing from when the traveling state information acquisition processing is started to when the wear amount estimation processing is ended in the present embodiment.

In step S101, the execution unit 61 of the vehicle 10A executes the traveling state information acquisition processing. Here, the traveling state information acquisition processing in the second embodiment is substantially the same as the traveling state information acquisition processing in the first embodiment.

In subsequent step S102, the execution unit 61 of the vehicle 10A determines whether the traveling state acquisition processing is completed. The execution unit 61 proceeds to the processing of step S103 when it is determined that the traveling state acquisition processing is completed (S102: YES), and returns to the traveling state information acquisition processing when it is determined that the traveling state acquisition processing is not completed (S102: NO).

In step S103, the execution unit 61 of the vehicle 10A causes the communication device 15 to transmit, via the vehicle external network NT, the traveling state information X stored in the memory 62 to the server apparatus 80.

In step S104, the execution unit 91 of the server apparatus 80 receives the traveling state information X transmitted from the vehicle 10A, and stores the received traveling state information X in a predetermined storage area of the memory 92.

In step S105, the execution unit 91 of the server apparatus 80 functions as the weight estimation unit M15A to execute the sample value derivation processing. Here, the sample value derivation processing in the second embodiment is substantially the same as the sample value derivation processing in the first embodiment, except that an execution condition in the present processing is that the traveling state information X is transmitted from the vehicle 10A, and that a processing target is the traveling state information X transmitted from the vehicle 10A, which are different from those in the sample value derivation processing in the first embodiment.

For example, in step S31 in FIG. 3, the execution unit 91 of the server apparatus 80 determines whether the traveling state information X is transmitted from the vehicle 10A. The execution unit 91 proceeds to processing of step S33 when it is determined that the traveling state information X is transmitted from the vehicle 10A (S31: YES), and ends the current processing when it is determined that the traveling state information X is not transmitted from the vehicle 10A (S31: NO).

In step S33, the execution unit 91 acquires the number of pieces of traveling state information X stored in the memory 92 as the information number M. In step S37, the execution unit 91 derives the sample value WS (N) of the vehicle weight based on the traveling state information X (N) stored in the memory 92.

In step S106 in FIG. 8, the execution unit 91 functions as the weight estimation unit M15A to execute the valid sample value selection processing. Here, the valid sample value selection processing in the second embodiment is substantially the same as the valid sample value selection processing in the first embodiment except that a processing target is the traveling state information X transmitted from the vehicle 10A, which is different from that in the valid sample value selection processing in the first embodiment.

For example, in step S51 in FIG. 4, the execution unit 91 of the server apparatus 80 acquires the number of pieces of the traveling state information X stored in the memory 92 as the information number M. In step S55, the execution unit 91 performs traveling state determination on the traveling state information X stored in the memory 92.

In step S107 and step S108 in FIG. 8, the execution unit 91 functions as the weight estimation unit M15A to execute the vehicle weight estimation processing and the wear amount estimation processing. The vehicle weight estimation processing and the wear amount estimation processing in the second embodiment are substantially the same as the vehicle weight estimation processing and the wear amount estimation processing in the first embodiment, respectively.

### Effects of Present Embodiment

In the present embodiment, the same effects as the effects (1-1) to (1-4) in the first embodiment can be obtained.

### Modifications

The plurality of embodiments described above can be modified as follows. The plurality of embodiments described above and the following modifications can be implemented in combination with each other within a technically consistent range.
In the plurality of embodiments described above, the valid sample value VWS derived from the traveling state information X satisfying the selection condition is selected from the sample values WS of the vehicle weight. However, the traveling state information X satisfying the selection condition may be selected from the traveling state information X, and the sample value WS may be derived based on the selected traveling state information X. Accordingly, since the processing of excluding the sample value WS based on the traveling state information X that does not satisfy the selection condition is omitted, the sample value derivation processing can be reduced.
In the plurality of embodiments described above, the selection condition is that the accelerator operation amount Accp, the drive torque Tod, the traveling speed Vs, the absolute value of the steering angle Str, the yaw rate Yr, the lateral force Fy, and the road surface gradient θ in the traveling state information X are values in predetermined ranges. However, the selection condition may be based on information other than the above-described information. For example, the selection condition may be based on weather, temperature, or an elapsed time after the ignition switch transitions from off to on.
In the plurality of embodiments described above, the vehicle weight is set to the predetermined weight WE when there are the small number of valid sample values VWS derived based on the traveling state information X satisfying the selection condition and when the traveling distance Lv is short. However, at least one of such conditions may be omitted.

For example, even when there are the small number of valid sample values VWS derived from the traveling state information X satisfying the selection condition, the estimated value W of the vehicle weight may be derived based on the valid sample values VWS. In this case, when the traveling distance Lv is short, since there are the small number of valid sample values VWS, it is still possible to prevent a decrease in the estimation accuracy of the wear amount ΔA of the friction portion 22 due to bias of the traveling state of the vehicle 10 or 10A, and it is also possible to prevent a decrease in the estimation accuracy of the wear amount ΔA due to the small number of valid sample values VWS.
In the plurality of embodiments described above, as the statistical processing, the processing of excluding the outlier of the valid sample values VWS based on the median VWSm of the valid sample values VWS and the processing of deriving the average value of the valid sample values VWS from which the outlier is excluded as the estimated value W of the vehicle weight are executed, but the statistical processing is not limited to such processing.

For example, the outlier may be excluded based on a variance, a standard deviation, or the average value of the valid sample values VWS. In addition, the median or a mode of the valid sample values VWS from which the outlier is excluded may be derived as the estimated value W of the vehicle weight. In addition, the processing of excluding the outlier of the valid sample values VWS may be omitted.
In the plurality of embodiments described above, the estimated value W of the vehicle weight is derived based on the plurality of pieces of traveling state information X acquired during one trip of the vehicle 10 or 10A, but the derivation is not limited thereto. For example, when the number of pieces of traveling state information X satisfying the selection condition reaches a predetermined number, the estimated value W may be derived using the predetermined number of pieces of traveling state information X satisfying the selection condition. The estimated value W may be derived using the traveling state information X acquired by the information acquisition unit M11 from when the vehicle 10 or 10A starts to when the vehicle 10 or 10A stops.
In the second embodiment, the information acquisition unit M11 and the information storage unit M13 are implemented in the vehicle 10A, and the weight estimation unit M15A and the wear amount estimation unit M17 are implemented in the server apparatus 80. However, functions corresponding to the information storage unit M13, the weight estimation unit M15A, and the wear amount estimation unit M17 may be implemented in any one of the vehicle 10A and the server apparatus 80, to an extent technically feasible.

For example, in the second embodiment, a function (server information storage unit M13A) corresponding to the information storage unit M13 may be implemented in the execution unit 91 of the server apparatus 80. In this case, the traveling state information X acquired by the information acquisition unit M11 may be transmitted from the vehicle 10A to the server apparatus 80 each time, and the transmitted traveling state information X may be stored each time in the predetermined storage area of the memory 92 by the server information storage unit implemented in the server apparatus 80. In this case, a storage capacity of the memory 62 of the vehicle 10A can be reduced.

In the second embodiment, a function (weight estimation unit M15) corresponding to the weight estimation unit M15A may be implemented in the vehicle 10A. In this case, the estimated value W of the vehicle weight estimated by the weight estimation unit M15 may be transmitted from the vehicle 10A to the server apparatus 80, and the wear amount ΔA of the friction portion 22 may be estimated by the wear amount estimation unit M17 implemented in the server apparatus 80 based on the transmitted estimated value W. In this case, an amount of information transmitted from the vehicle 10A to the server apparatus 80 can be reduced.

In the second embodiment, a function (wear amount estimation unit M17) corresponding to the wear amount estimation unit M17 may be implemented in the vehicle 10A. In this case, the estimated value W of the vehicle weight estimated by the weight estimation unit M15A implemented in the server apparatus 80 may be transmitted from the server apparatus 80 to the vehicle 10A, and the wear amount ΔA of the friction portion 22 may be estimated by the wear amount estimation unit M17 implemented in the vehicle 10A based on the transmitted estimated value W.

In the second embodiment, the weight estimation unit M15A is implemented in the server apparatus 80. However, a part of functions of the weight estimation unit M15A may be implemented in the vehicle 10A.

For example, in the second embodiment, a function corresponding to the sample value derivation processing of the weight estimation unit M15A (hereinafter, referred to as a “sample value derivation unit”) may be implemented in the vehicle 10A. In this case, the sample value WS derived by the sample value derivation unit may be transmitted from the vehicle 10A to the server apparatus 80, and the vehicle weight may be estimated, based on the transmitted sample value WS, by a remaining function of the weight estimation unit M15A implemented in the server apparatus 80.

In the second embodiment, in the weight estimation unit M15A, the sample value derivation unit and a function corresponding to the valid sample value selection processing (hereinafter, referred to as a “valid sample value selection unit”) may be implemented in the vehicle 10A. In this case, the valid sample value VWS selected by the valid sample value selection unit may be transmitted from the vehicle 10A to the server apparatus 80, and the vehicle weight may be estimated, based on the transmitted valid sample value VWS, by the remaining function of the weight estimation unit M15A implemented in the server apparatus 80.

In the plurality of embodiments described above, the conditions (A1) to (A10) are set as the selection condition, and it is determined that the selection condition is satisfied when all of the conditions are satisfied, but the determination is not limited thereto.

Specifically, if a predetermined number or more of the conditions (A1) to (A10) are satisfied, it may be determined that the selection condition is satisfied. For example, when at least one of the conditions (A1) to (A4) is satisfied, it may be considered that there is no possibility that the vehicle 10 or 10A is creeping, when at least one of the conditions (A5) to (A7) is satisfied, it may be considered that there is no possibility that the vehicle 10 or 10A is cornering, and if at least one of the conditions (A1) to (A4), at least one of the conditions (A5) to (A7), and the conditions (A8) to (A10) are satisfied, it may be determined that the selection condition is satisfied.

Another condition may be added to the conditions (A1) to (A10), or one or a plurality of conditions may be excluded from the conditions (A1) to (A10). For example, one or more conditions may be excluded from the conditions (A1) to (A4), and one or more conditions may be excluded from the conditions (A5) to (A7).

The control apparatus 60, the vehicle control apparatus 60A, and the server control apparatus 90 may be implemented as a circuit including one or more processors that operate according to a computer program, one or more dedicated hardware circuits such as dedicated hardware that executes at least a part of processing of various types of processing, or a combination thereof. Examples of dedicated hardware include an application-specific integrated circuit (ASIC).

### Other Technical Ideas

Technical ideas that can be grasped from the plurality of embodiments and the modifications will be described below.
(A) It is preferable that the selection condition includes at least one of a condition that the braking or driving force is equal to or larger than the braking or driving force determination value, a condition that the accelerator operation amount is equal to or larger than the operation amount determination value, a condition that the drive torque is equal to or larger than the drive torque determination value, a condition that the traveling speed is equal to or larger than the traveling speed determination value, a condition that an acceleration or deceleration is equal to or larger than an acceleration or deceleration determination value, a condition that the absolute value of the steering angle is equal to or smaller than the steering angle determination value, a condition that the absolute value of the gradient of the road surface on which the vehicle travels is equal to or smaller than the gradient determination value, and a condition that the gradient of the road surface indicates an uphill road.
(B) It is preferable that, in the statistical processing, the weight estimation unit derives the estimated value of the vehicle weight based on only the sample value whose difference from a median or an average value of the plurality of sample values is less than a difference determination value among the plurality of sample values.
(C) It is preferable that the weight estimation unit derives the estimated value of the vehicle weight based on the average value of the plurality of sample values in the statistical processing.
(D) It is preferable that the first control apparatus provided in the vehicle and the second control apparatus provided outside the vehicle are provided,
the first control apparatus includes the information acquisition unit, and
the second control apparatus includes the weight estimation unit.
(E) It is preferable that the second control apparatus further includes the information storage unit.
(F) It is preferable that the vehicle includes the friction brake configured to apply a braking force to the wheel by bringing the friction portion into contact with the rubbed portion, and
the wear amount estimation unit is provided, which is configured to estimate a wear amount of the friction portion during one trip based on an estimated value of the vehicle weight derived by the weight estimation unit when a traveling distance of the vehicle during one trip from when the ignition switch of the vehicle is turned on to when the ignition switch is turned off is equal to or longer than a predetermined distance, and to estimate the wear amount of the friction portion during one trip based on a design value of the vehicle weight set based on specifications of the vehicle when the traveling distance of the vehicle during one trip is shorter than the predetermined distance.

The expression “at least one” used in the present specification means “one or more” desired options. As an example, the expression “at least one” used in the present specification means “only one option” or “any combination of two or more options” when the number of options is three or more.

1. A vehicle control system comprising:
an information acquisition unit configured to acquire a braking or driving force and an acceleration of a vehicle as traveling state information each time;
an information storage unit configured to store the traveling state information acquired by the information acquisition unit; and
a weight estimation unit configured to derive an estimated value of a vehicle weight based on the traveling state information satisfying a predetermined selection condition among a plurality of pieces of the traveling state information stored by the information storage unit, wherein
the selection condition is a condition under which disturbance in derivation of the estimated value of the vehicle weight by the weight estimation unit is reduced.

2. The vehicle control system according to claim 1, wherein
the information acquisition unit acquires, as the traveling state information, at least one of an accelerator operation amount, a drive torque of a drive shaft of the vehicle, a traveling speed of the vehicle, a steering angle, a yaw rate of the vehicle, a lateral force of the vehicle, and a gradient of a road surface on which the vehicle travels, and
the selection condition is that a value acquired as the traveling state information is within a predetermined range.

3. The vehicle control system according to claim 2, wherein
the weight estimation unit
derives a plurality of sample values of the vehicle weight based on the traveling state information satisfying the selection condition, and
derives an estimated value of the vehicle weight by performing statistical processing on the plurality of sample values.

4. The vehicle control system according to claim 3, wherein
when there are a predetermined number or more pieces of the traveling state information satisfying the selection condition, the weight estimation unit derives an estimated value of the vehicle weight based on the predetermined number or more pieces of the traveling state information.

5. The vehicle control system according to claim 2, wherein
when there are a predetermined number or more pieces of the traveling state information satisfying the selection condition, the weight estimation unit derives an estimated value of the vehicle weight based on the predetermined number or more pieces of the traveling state information.

6. The vehicle control system according to claim 1, wherein
the weight estimation unit
derives a plurality of sample values of the vehicle weight based on the traveling state information satisfying the selection condition, and
derives an estimated value of the vehicle weight by performing statistical processing on the plurality of sample values.

7. The vehicle control system according to claim 6, wherein
when there are a predetermined number or more pieces of the traveling state information satisfying the selection condition, the weight estimation unit derives an estimated value of the vehicle weight based on the predetermined number or more pieces of the traveling state information.

8. The vehicle control system according to claim 1, wherein
when there are a predetermined number or more pieces of the traveling state information satisfying the selection condition, the weight estimation unit derives an estimated value of the vehicle weight based on the predetermined number or more pieces of the traveling state information.
